(19) United States
(12) Patent Application Publication
(10) Pub. No.: US 2017/0157758 A1
(43) Pub. Date: Jun. 8, 2017

(54) CLIP DISPENSING MEANS AND CLIPS AND STORAGE MEANS THEREFORE

(71) Applicant: Anthony Richard HOWE, Lincolnshire (GB)

(72) Inventor: Anthony Richard HOWE, Lincolnshire (GB)

(21) Appl. No.: 15/321,592

(22) PCT Filed: Jun. 17, 2015
(86) PCT No.: PCT/GB2015/051771

§ 371 Date: Dec. 22, 2016

(30) Foreign Application Priority Data
Jun. 25, 2014 (GB) 1411353.4
May 7, 2015 (GB) 1507887.6

(51) Int. Cl. B25C 1/06; B25C 3/00; F16B 15/08; B25C 1/02

(52) U.S. Cl. CPC B25C 1/06; B25C 1/02; B25C 3/004; F16B 15/08

(57) ABSTRACT

The invention relates to a clip dispenser for the controlled dispensing and fixing of clips for use to position an elongate member such as a cable or pipe with respect to a surface. The dispensing means has a housing having a surface with a dispensing aperture through which a clip including a securing means in the form of, for example, a nail can be dispensed and a driver assembly is provided adjacent the aperture and which can be operated to drive the nail into the surface to which the clip and elongate member are to be fixed. The clips can be provided initially joined together to form a magazine cassette or cartridge from which the leading clip can be separated by the use of the apparatus.

The present invention relates to a clip dispenser and clips which are for use in engagement with a portion of an elongate member such as, for example, a cable or pipe.

It is often desirable to secure a length of cable or pipe to a surface at spaced intervals and it is often desirable to lay the cable or pipe along a wall, along a skirting board or around a door frame. Such a cable might be a television aerial cable, telephone cable, mains electric cable, or loudspeaker cable, or the like in order to allow the cable to pass from a first location to a second location in as neat a manner as possible so that the cable is not unnecessarily unsightly.

One conventional method of doing this is by the use of clips which comprise a body portion having location means into which a portion of the elongate member is located and an engagement portion with a channel for the receipt of a nail which is nailed into the surface, such as the wall or skirting board, to secure the clip and hence elongate member in position. The clips have to be individually spaced and located and then held whilst the nail is hammered into the engagement position by a person who would obtain each clip from a container or box. This is a time consuming task, hammering each clip one by one into a surface, especially when one considers that the clips may have to be hammered into positions in difficult to access locations, at a height which requires, for example, the person to be standing on a ladder and/or in difficult environmental conditions. Each clip is applied to the cable or pipe by holding each clip with thumb and fingers in one hand, and then hammering the nail into the surface using the other hand. Invariably thumb and fingers get hit with the hammer, or sometimes the cable can be hit by mistake and damaged. At the same time is it also necessary to support the elongate member in the desired location using ones hands which can be awkward.

The invention seeks to provide a solution to this problem which provides an advantageous solution over and above the prior art method and any known apparatus.

According to the present invention in a first aspect there is provided a dispenser apparatus for dispensing a clip for securing an elongate member in position, said apparatus including;

a) a housing having a base portion including an aperture through which a said dip including a body portion and at least one securing means is dispensed,
b) a driver assembly adapted to be movable to contact the securing means of the dip to drive the said securing means of the clip positioned at the aperture into a surface,
c) a storage means to receive a plurality of clips and to allow a leading clip of the plurality of clips to be positioned at the said aperture to be dispensed and wherein the longitudinal axis of the storage means is provided at an angle that inclines from at least the portion of the base at which the said aperture is located and/or surface into which the clip is to be fixed.

Typically the storage means is provided within the housing or defines an edge of the same and has an opening at one end to allow the introduction of clips therein.

Typically the dispensing apparatus includes delivery means to deliver the next clip to the dispensing aperture when the leading clip has been dispensed from said aperture.

In one embodiment the plurality of clips are arranged at an angle which is less than 90 degrees to the axis along which the driver assembly moves when driving the securing means into position. In one embodiment the said angle is in the range of 85-20 degrees to the said axis. In one embodiment the axis of the portion of the base in which the said aperture is located is substantially perpendicular to the axis of movement of the driver assembly.

Preferably the driver assembly has a sleeve which engages the clip, typically in the portion around the securing means, and a punch which reciprocates within the sleeve. A hammer can be provided as part of the driver assembly to hit the punch by means of a powered mechanical actuation or alternatively the hammer can be separate and used by a person to hit the punch of the dispensing means. In either case the hammer hits the punch to move the same to hit and drive the securing means of the clip into a surface adjacent to which the dispensing means is positioned. Preferably the punch extends through a punch aperture in the housing.

Preferably the driver assembly can move from a first position engaging a clip at the aperture to a second position away from the aperture to allow the delivery means to deliver the next clip to the aperture.

Preferably the housing has an elongate channel to support and position the elongate member in the form, for example, of a cable, and the aperture leads into the channel.

Preferably the storage means can receive the plurality of clips which are joined together to form a cassette, cartridge or magazine. The leading clip is then successively separated from the remainder of the clips as the same is driven into the surface and thereby secure the elongate member in position. Typically when one cartridge, cassette or magazine is exhausted a new one can be inserted.

In one embodiment the storage means can be range taking in that guide means provided within the same can be receive, or be adapted to receive cassettes, cartridges or magazines of different sizes of clips and thereby allow the dispensing means to be range taking to dispense different sized clips therefrom.

In one embodiment the clip body is provided with a recess to allow the location of a portion of an elongate member therein. In another embodiment the clip is provided with a larger recess, or plurality of recesses, in order to allow a number of elongate member portions to be located therein side by side.

In one embodiment the clips are joined together as part of the magazine, cassette or cartridge. In one embodiment the clips are joined together such that the same are provided in a stepped configuration, with the leading clip being at one end and the last clip at the opposing end. Typically the securing means in each clip is provided with a longitudinal axis along which the same is driven and the said longitudinal axes of said respective clips are substantially parallel when the clips are joined together.

Typically the stepped configuration means that the longitudinal axis of the magazine cassette or cartridge substantially matches that of the storage means of the housing in which the same is located for dispensation of clips therefrom.

In one embodiment the join is achieved by a web of material which extends and joins adjacent clips. In one embodiment a dovetail join is provided between adjacent clips.

Typically the join between the leading clip and the next clip in the supply is broken or released during, or once, the leading clip nail has been moved into position.

In one embodiment a cutter is provided, typically as part of the driver assembly to break the join or, alternatively, the force of movement of the nail and hence dip into position with respect to the dispenser is sufficient to break the join.

The stepping and hence staggering of the clips at different levels in the cassette, magazine or cartridge which is formed and the location of the same in that position in the storage means aids the task of inserting the securing means nail of the leading clip in position by passing the same over the elongate member. Typically, the leading clip is positioned to substantially contact the surface and be positioned over the elongate member at the location of the driver assembly of the dispenser and with the remainder of the clips in the cassette, magazine or cartridge at a raised position with respect to the base so that they do not contact with the surface or elongate member and therefore do not interfere with the same during the movement of the driver assembly to contact the leading clip securing means.

In one embodiment the driver assembly is moved by manual actuation caused by contact of a hammer with the driver assembly held by a user. In one embodiment the driver assembly is actuated by a power driving means provided within the housing with the power provided by one or more power cells provided as part of the housing or by an external power source, such as mains power, in contact with the housing. In this case, and in one embodiment, the apparatus does not move until a button at the base is moved by the contact of the base with the surface and this then allows electrical contact to be achieved.

In one embodiment the housing includes a means for emitting at least one laser light which defines a line along which the elongate member is to be secured in position. The laser line therefore acts as a guide for the positioning of the elongate member with respect to the surface in advance of the housing and also for the movement of the housing as it is moved to the next position for the application of a dip.

In a further aspect of the invention there is provided a supply of clips, each clip including a body with location means for location of a portion of an elongate member therein and an engagement portion with a channel for the receipt of a nail and wherein the clips are arranged with a leading clip joined to the following clip and the successive adjacent clips are joined together to form the clip supply.

In one embodiment the join between successive adjacent clips is achieved by a portion of material which can be broken to release a clip from the supply. Typically the break in a join is between the leading clip and the adjacent clip and this occurs when the leading clip is being secured in position on the elongate member and surface.

In an alternative embodiment the join is created by a joint, such as a dovetail join, between adjacent clips with one of the clips including a male joining formation and the adjacent clip including a female joining formation such that the relative movement of the leading clip with respect to the adjacent clip while the leading clip is being moved into the engaging position allows the male and female joining formations to slide apart and hence free the leading clip from the clip supply.

In one embodiment the supply of clips are provided, when joined together is a stepped configuration with the securing means of the respective clips each having a longitudinal axis and the said axes are substantially parallel.

In one embodiment the said clip includes a body with a location means for a portion of at least one elongate member and an engagement portion with a channel for the receipt of a securing means nail therethrough and a joining portion which allows the clip to be joined to an adjacent clip.

In one embodiment the joining portion is required to be broken to allow the separation of the clip from the clip supply. In another embodiment the joining portion is formed from at least two parts, which parts can be moved apart in order to allow the clip to be released from the clip supply.

According to the present invention in a further aspect there is provided A dispenser apparatus for dispensing a clip for securing an elongate member in position, said apparatus including;

a) a housing having a surface with a base portion including an aperture through which a said clip including a body portion and at least one securing means is dispensed,
b) a driver assembly adapted to be movable to contact the securing means of the clip to drive the said securing means of the dip positioned at the aperture into a surface, and
c) a storage means to receive a plurality of clips and to allow a leading clip of the plurality of clips to be positioned at the said aperture to be dispensed and wherein the said plurality of clips are provided as a magazine, cartridge or cassette of the clips.

In one embodiment the dips are joined together to form the magazine cartridge or cassette, with the leading clip applied by releasing the said join with the adjacent clip.

In one embodiment the said release is achieved by breaking the join by the movement of the driver assembly into contact with the joining portion of material.

In one embodiment the release of the join is achieved by the relative movement between the leading clip as it is applied into position to secure the elongate member and the adjacent clip.

In one embodiment the magazine, cartridge or cassette includes guide means in which the plurality of clips are held in a required configuration.

Typically the said clips are located together so as to have a stepped configuration but in an alternative configuration can be provided so as to be in line.

Specific embodiments of the invention will now be described with reference to the accompanying drawings; in which:

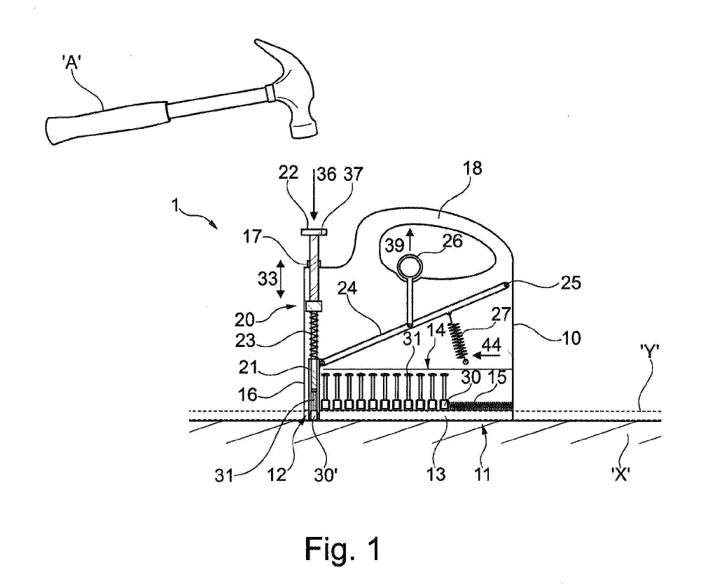

FIG. 1 shows a cross section view of a dispensing apparatus in accordance with one embodiment prior to driving a securing means of a leading clip from a clip supply,

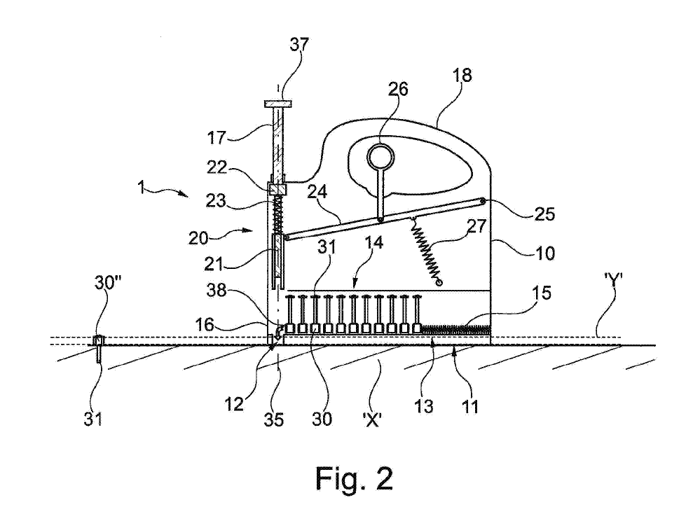

FIG. 2 shows a cross section view of the dispensing apparatus of FIG. 1 having been removed from a surface into which a clip has been dispensed,

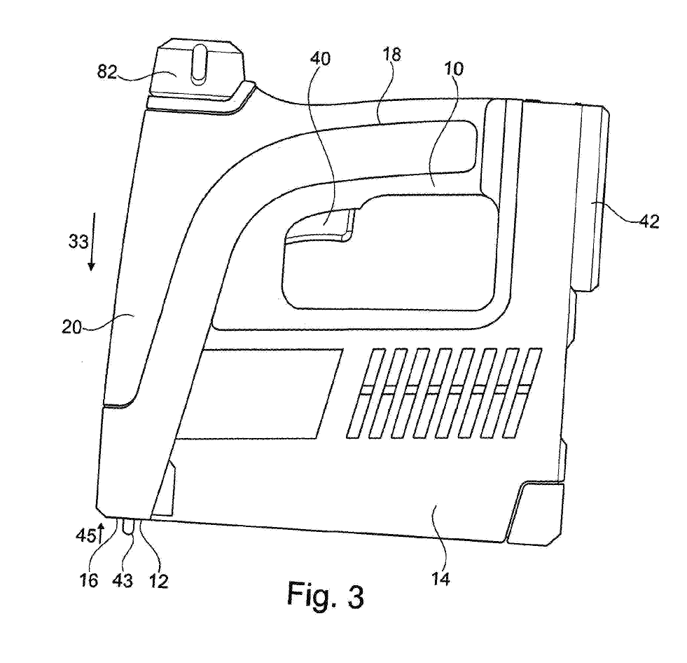

FIG. 3 illustrates a further embodiment of clip dispensing apparatus in accordance with the invention;

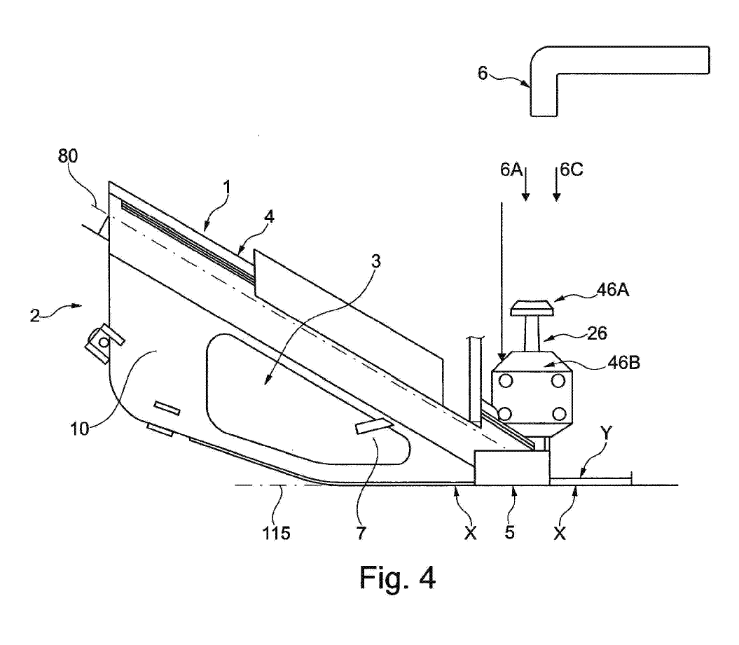

FIGS. 4-10 illustrate a further embodiment of dispensing apparatus in accordance with the invention and clip supplies therefore;

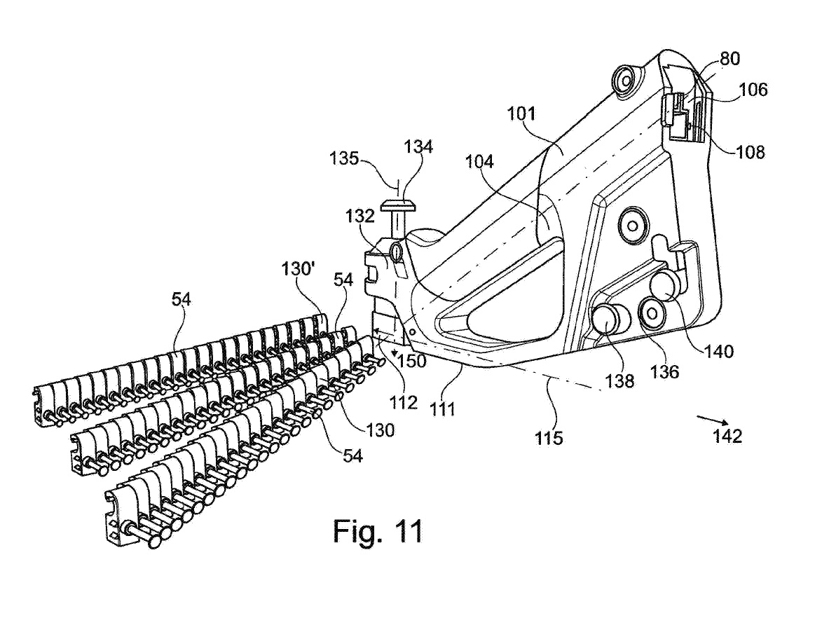

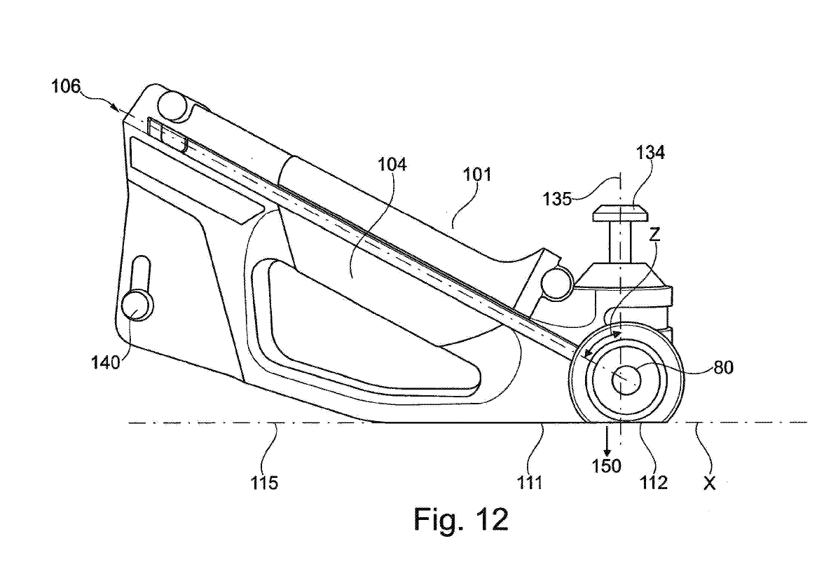

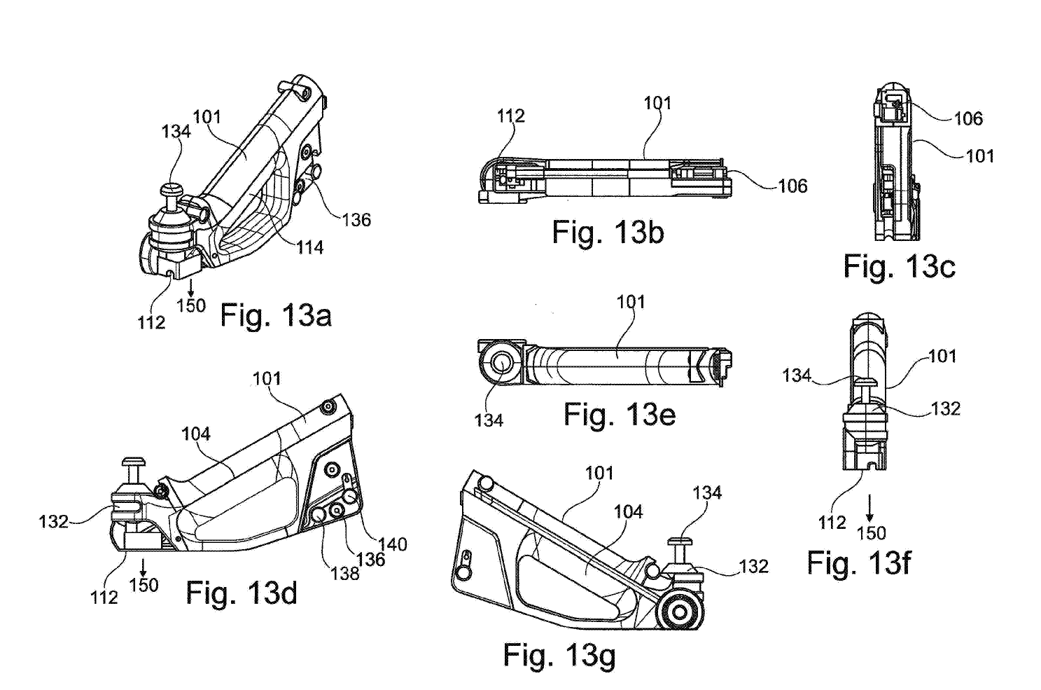

FIGS. 11-13g illustrate a further embodiment of apparatus in accordance with the invention and clip supplies therefore; and

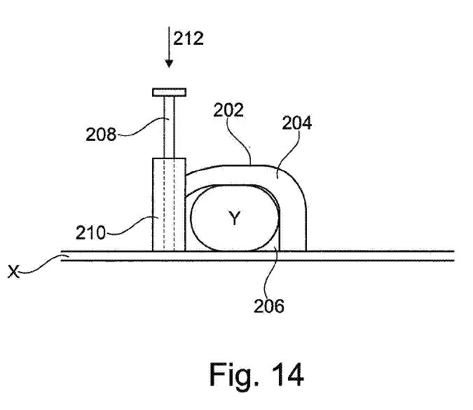

FIG. 14 illustrates one form a of a clip used in accordance with the invention.

Referring firstly to FIGS. 1 and 2 there is shown a clip dispensing apparatus 1 in accordance with one embodiment of the invention. The apparatus is provided in position for use with respect to a surface which, in this case, is in the form of the top edge of a skirting board X and onto which an elongate member Y is to be secured in position at spaced intervals by clips dispensed from the apparatus.

The dispensing means 1 has a housing 10 with a base 11 which includes an aperture 12 through which a clip 30 with a securing means in the form of a nail 31 and of, for example, the type illustrated, can be dispensed. The base 11 also includes guide means in the form of an elongate channel section 13 running along the length thereof to accommodate and guide a length of the elongate member which is to be held in position by the clips at spaced locations. This ensures that the cable Y is in the correct position with respect to the aperture 12 when the leading clip 30′ is dispensed and nailed into position therethrough and onto the skirting board.

In the housing, and above channel section 13 there is provided a storage means 14 for the receipt of a supply of a plurality of cable clips 30 therein, or for the receipt of a cassette, cartridge or magazine formed by the clips or in which the clips are held. A delivery means in the form of a push plate and spring 15 is provided to bias the supply of clips 30 towards aperture 12 so that the leading clip 30′ is aligned with the aperture 12. This is aided by stop 16 which aligns the leading clip in position above the aperture 12 for dispensation. Different interchangeable cassettes, cartridges or magazines can be provided to allow the storage and dispensation of different sizes of dips as long as the clips can be moved through the aperture 12 at the point of dispensation.

A driver assembly 20 is provided adjacent to, and axially aligned with, the aperture 12. The driver assembly 20 has a sleeve 21, which, when lowered engages with the leading clip which is to be dispensed around the nail 31, and a punch 22 which is provided for reciprocal linear movement within the sleeve along the longitudinal axis 35 shown in FIG. 2 and as indicated by arrow 33.

The punch is provided to be hit at its exposed head 37, in this embodiment by a hammer, A, which is moved in the direction indicated by arrow 36 to drive the punch towards the nail 31 in the leading clip 30′ and hence drive the nail into the surface X and thereby retain the clip in contact with the surface and with the elongate member Y positioned between the clip and the surface as illustrated by previously applied dip 30″ in FIG. 2. The punch 22 extends from the sleeve through an aperture 17 in the top edge of the housing 10 and the punch 22 is biased to the raised position by a spring 23.

The driver assembly 20 can move from a first position as shown in FIG. 1 in which it engages the leading clip 30′ in the clip aperture 12 to a second position as shown in FIG. 2 spaced away from the aperture 12 in order to allow the clip delivery means to deliver the next clip which is to be dispensed to the aperture 12 in the direction of arrow 38 and so become the new leading clip. To do this, the sleeve 21 is connected, and pivoted, with respect to one end of a rod 24 and the other end of the rod is connected by a pivot 25 to housing 10. The rod is connected to a pull ring 26 which can be raised as indicated by arrow 39 to cause the drive assembly 20 to be moved up to the position shown in FIG. 2 and hence the spring 15 can move the clip supply in the direction 41 to move the new leading clip 30′ to a position above the aperture 12 and below the drive assembly 20. The pull ring can then be released. To operate the dispensing means 1 to dispense a clip, the housing 10 is held in the hand by a user and positioned with respect to a surface, such as skirting board X, with the elongate member in the form of cable Y located in the channel section 13, as shown in FIG. 1.

In FIGS. 1 and 2 the exposed end 37 of the punch 22 is then struck by the hammer A to move the punch towards the leading clip position in the housing and in particular to contact the nail 31 in the leading clip and thereby push the nail 31 into the skirting board X. The spring 23 is compressed, so securing the clip 30′ over the cable Y. When the hammer is removed from the punch 22, the spring 23 biases the punch 22 away from the sleeve 21 so that the same is ready for the next hammer blow to be made. The leading clip is moved into position by the push plate and spring 15 to push the clips 30 in the storage means 13 such that the leading clip 30′ is moved towards the aperture 12 until the leading clip abuts against stop 16 and is aligned with aperture 12.

In the embodiment shown in FIG. 3 the apparatus is powered. The housing 10 is provided with a handle portion 18 which includes a trigger 40 for operation by the user. The housing is also provided with a portable power supply in the form of power cell 42. The provision of the power cell enables the apparatus to include a powered driver assembly 20 which therefore does not require the use of a separate hammer. In this embodiment the driver assembly 20 is again provided in a similar position so as to exert the driving force in the direction of arrow 33 on the nail of the leading clip in the clip supply. Once more the clip supply can be provided in the storage means 14 and moved towards the dispensing aperture 12. In this case the movement of the punch is operated by the depression of the trigger 40 but power can only be provided to the driver assembly when a safety button 43 is depressed in the direction of arrow 45 by the contact with the surface X into which the clip is to be fixed and when it is depressed electrical contact between the power source and the driver assembly is possible. This ensures that the clip cannot be driven out of the aperture 12 when the base is not in contact with the surface and so prevents the possibility of the “firing” of the clip from the housing and hence prevents the possibility of injury.

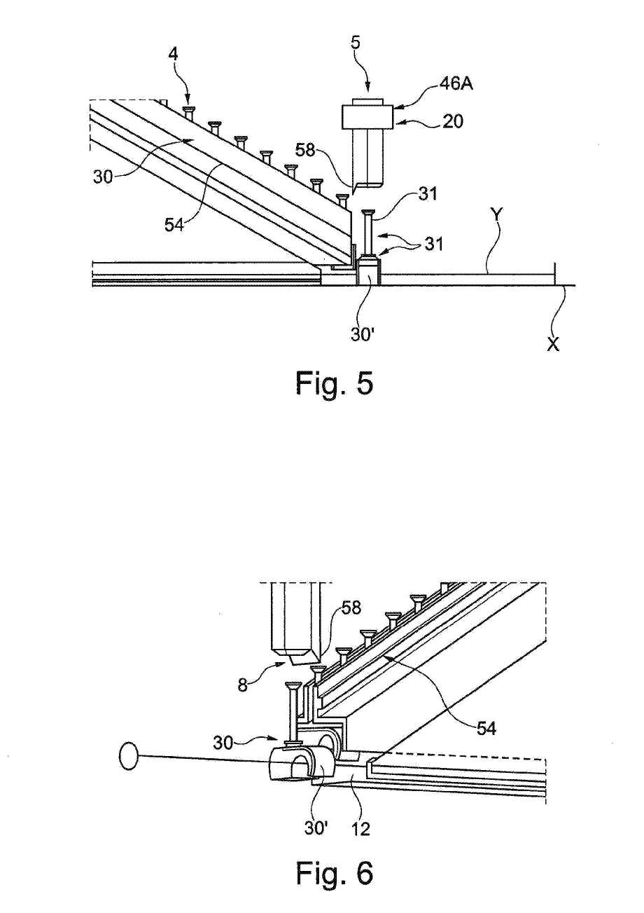

The driver assembly is moved to a position away from the aperture 12 as shown in FIGS. 4 and 5 by use of an electrical solenoid 46C which is selectively operated by the user via the trigger 40. As illustrated in FIGS. 4 and 5 the operation of the trigger 40 causes the solenoid to move from the position shown in FIG. 4 to the position shown in FIG. 5 by moving the punch head 46A away from the pin 31 of the clip 30′ and so stretches a spring 46B in the driver assembly. The solenoid 46C is then turned off and the stretched spring 46B is then released to drive the punch 46A onto the pin 31 so driving the pin through the aperture 12 and into the surface X.

The housing 10 of FIG. 3 may also include a guide line emitter such as that generated by a laser unit mounted on the housing. The guide line is emitted onto the surface X in advance of the housing so as to provide a guide for the positioning of the cable which is subsequently to be fixed in position.

In the embodiment shown in FIGS. 3-5 the driving force is created internally of the housing 10 by the drive assembly upon use of the trigger 40 in order to allow the power supply to be used to move the driver assembly 22 to drive the nail 31 of the leading clip 30′ into position. Power for operation of the solenoid 46C is provided from the portable power cells 42 or a mains power supply to the dispensing means can be provided.

If desired, the driver assembly can be adjustable, e.g. by altering the tension of spring 46B when stretched by the solenoid 46C, to drive a clip pin 31 at variable forces. Thus, a different force, and number of force impacts, can be used to drive the pin 31 depending on the nature of the surface it is being driven into (e.g. brick, wood, plastic or plaster).

When the leading clip 30′ has been secured into the skirting board X, the dispensing means 1 can be moved to a different position along the length of cable Y by preferably sliding the channel section 13 along the cable Y to tension and straighten it. When the position for the application of the next leading clip 30′ along the length of cable is reached, the dispensing means 1 is positioned and the above steps repeated to apply the next leading clip 30′.

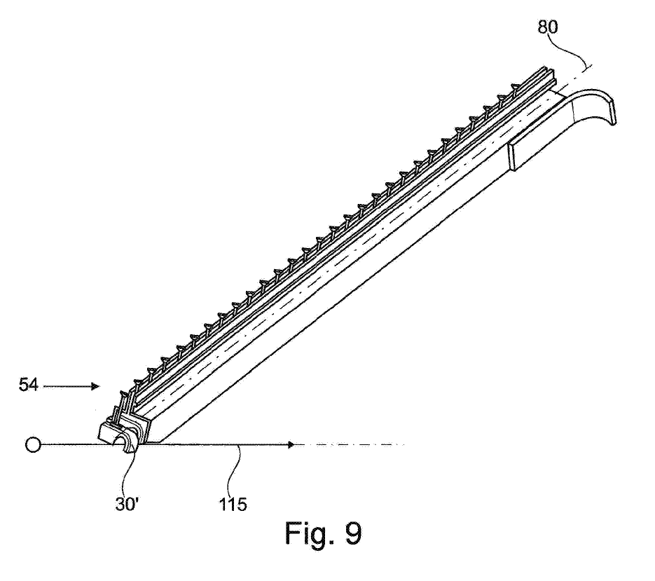

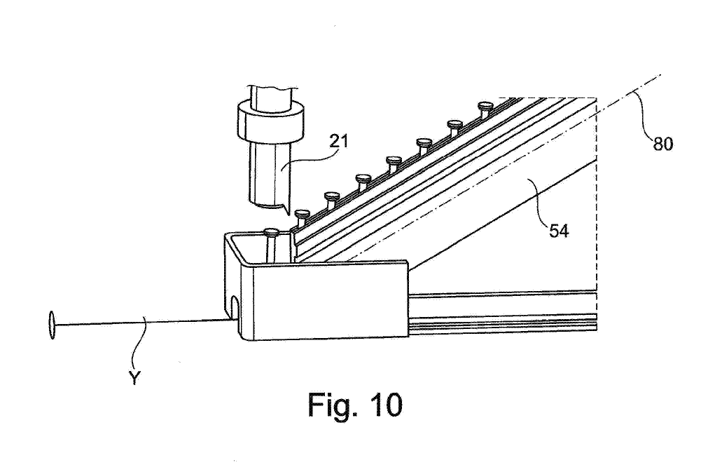

In the embodiments of FIGS. 1-3 the supply of clips is provided in a line substantially parallel with the surface X and base of the housing. In FIGS. 4-13g the supply of clips is provided such that the same are provided in a stepped configuration as shown in, for example, FIGS. 9 and 10, and held therein by joining means between the adjacent cable clips and/or the storage means in the housing such that when in position in the storage means the leading clip is the closest to the base of the housing and the remaining clips in the clips supply are provided along a longitudinal axis 80 which inclines at an angle from the aperture and at least a portion of the base 11, 111 of the housing adjacent to the aperture and the longitudinal axis 115. Furthermore, the longitudinal axis 80 of the clip supply when in the housing is provided at an angle “Z” to the longitudinal axis 35, 135 along which the driver assembly punch is moved to provide a driving force as shown in FIG. 12. The angle Z is less than 90 degrees and typically in the range of 20 to 85 degrees from the axis 135 as shown in FIG. 12. It will be seen in the Figures that the nail of each clip has a longitudinal axis and when the clips are held in the storage means or magazine, cassette or cartridge the respective longitudinal axes of the nails are held in parallel to each other and typically parallel to the axis 35, 135.

Turning now to FIGS. 11-13g there is illustrated a preferred embodiment of a dispensing apparatus in accordance with the invention. In this embodiment the dispensing apparatus 101 is again provided with a clip dispensing aperture 112 which allows a leading clip 130′ from a clip supply 54 to be dispensed and fixed in the direction of arrow 150 into the underlying surface X such as for example a skirting board and to secure the elongate member such as a cable in position with respect thereto. In this embodiment the dispensing means 101 is provided with a storage means 104 which is inclined so as to substantially match the angle of inclination of the longitudinal axis 80 of the clip supply 130 which as previously described, includes the clips located in a stepped arrangement and in, or forming, a magazine, cassette or cartridge 54, as shown in FIG. 11, and described in greater detail subsequently. The clip supply is introduced into the storage means 104 at the loading aperture 106 and guided by guide means 108 along the storage means so that the leading clip 130′ in the magazine lies above the dispensing aperture 112 at the base 111 of the housing.

When the leading clip 130′ is in position, a downward force along the axis 135 is exerted onto the top of the leading clip pin so as to move the leading clip 130′ in the direction of arrow 150 and hence release the leading clip 130′ from the magazine as it passes through the aperture 112 and into contact with the surface X. The downward force is provided by the driver assembly 132 mounted in the dispensing apparatus 101 above the position of the leading clip 130′ and dispensing aperture 112. As already described, the driving force can be generated manually, such as by a hammer blow on the driver assembly punch head 134 in the direction 150, as in this embodiment, or, alternatively, powered drive means may be provided within the dispensing apparatus.

The dispensing apparatus 101 in this embodiment is also shown to include cable guide means 136 which comprise first and second rollers 138, 140, with the roller 140 at least being linearly movable to guide the elongate member and retain the same along the axis 115 as the dispensing means 101 is moved along the same axis 115 in the direction 142 to dispense clips at spaced locations along the cable to retain the same in position. The cable passes between the rollers 138, 140 and is thereby retained in the correct linear position.

Turning now to FIGS. 5-10 there is illustrated details of the clip and clip supply in accordance with one embodiment of the invention. As already described the dispensing apparatus includes storage means, 14, 104 for the receipt of a clip supply in which the clips are provided in a stepped configuration so that each successive clip from the leading clip is provided at a greater distance in both X and Y axes from the leading clip and hence from the aperture 12, 112 at the base of the housing and surface X when the apparatus is in the dispensing position. The clips can more easily be successively moved to the aperture from which the leading clip is dispensed in a direction which is substantially parallel with the longitudinal axis of the driver assembly 20, whilst also allowing the clips other than the leading clip to be kept clear of the base portion, the elongate cable and the driver assembly.

The clip supply 54 is formed by a series of clips which are held in the stepped configuration to form a magazine or cartridge of clips. In one embodiment the clips are held together as a unitary supply by bridging means, 56 to thereby form a cartridge, cassette or magazine.

In one embodiment the drive assembly punch 46a can include a cutter portion 58 as shown in FIGS. 5 and 6, which, when the punch is moved down on to the nail to drive the same, reaches a position to cut through the frangible bridging means between the leading clip 30′ and the adjacent clip and so severs the leading clip from the clip supply as shown in FIGS. 5 and 6.

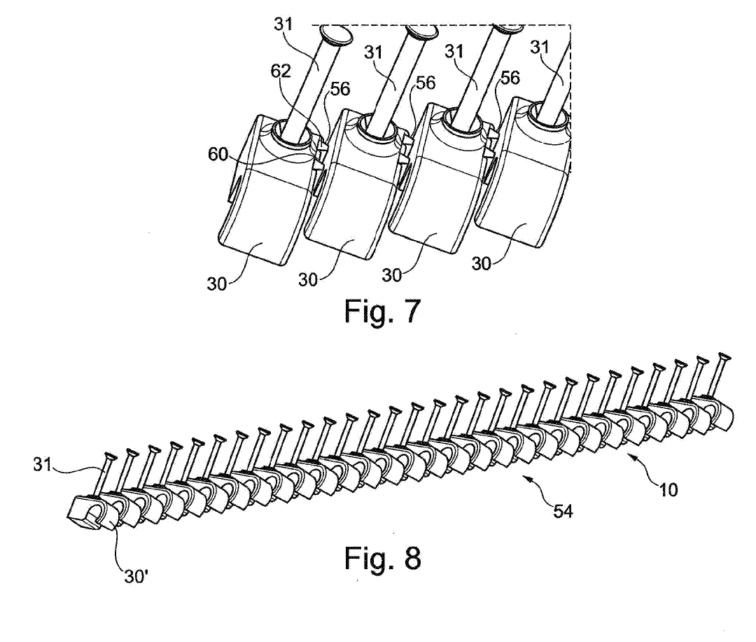

In FIGS. 7 to 10 there is provided a clip supply 54 in the form of a magazine which can be inserted into the storage area of the housing as a unitary item. The frangible portions are shown in more detail in FIG. 7 as including portions 60, 62. It is also shown how the clips 30 are provided in a stepwise manner such that the magazine is provided in the housing at the inclined angle to the surface X when the housing is brought into the dispensing position on the surface X.

In one embodiment the dispensing means includes a metering means to secure a clip on the elongate member at predetermined and metered spaced intervals. A user actuation means such as a control knob 82 shown in the embodiment of FIG. 3 is provided to allow the user to adjust the predetermined spacing interval.

As shown in FIG. 14 the clip 202 has a body 204 provided with a recess 206 in which the portion of the cable Y is retained when the clip is in position. The securing means in the form of the nail 208 is located in and passes through a channel 210 in the body as a driving force is applied down in the direction of arrow 212 to drive the nail into the surface X.

Alternatively the body and pin may be provided separately but with engagement means which allow the pin to be attached to the body so as to form the unitary clip.

The invention may take a form different to that specifically described above.

Further modifications will be apparent to those skilled in the art without departing from the scope of the present invention.

1. A dispenser apparatus for dispensing a clip for securing an elongate member in position, said clip including a body portion and at least one securing means, said apparatus including;
a) a housing having a base portion including an aperture through which securing means are dispensed,
b) a driver assembly adapted to be movable to contact the securing means of the clip to drive the said securing means of the clip positioned at the aperture into a surface,
c) a storage means to receive a plurality of said securing means and to allow said leading securing means of the plurality of securing means to be positioned at the said aperture to be driven and dispensed and wherein the longitudinal axis of the storage means is provided at an angle that inclines from at least the portion of the base at which the said aperture is located and/or surface into which the clip is to be fixed.

2. The dispenser apparatus according to claim 1 including delivery means to deliver the next clip securing means to the dispensing aperture once a leading clip securing means has been dispensed from said aperture.

3. The dispenser apparatus according to claim 1 wherein the plurality of clips are arranged at an angle which is less than 90 degrees to the longitudinal axis along which at least part of the driver assembly moves when driving the securing means of the leading clip.

4. (canceled)

5. The dispenser apparatus according to claim 3 wherein the longitudinal axis of the portion of the base in which the said aperture is located is substantially perpendicular to the driver assembly axis of movement.

6. The dispenser apparatus according to claim 1 wherein the driver assembly has a sleeve which engages the clip and a punch which reciprocates to provide the driving force and the hammer is provided as part of the driver assembly to hit the punch by means of a Dowered mechanical actuation.

7. (canceled)

8. (canceled)

9. (canceled)

10. (canceled)

11. The dispenser apparatus according to claim 1 including guide means to support and position the elongate member.

12. The dispenser apparatus according to claim 1 wherein the storage means receives a plurality of clips which are joined together to form a cassette, cartridge or magazine and the leading clip is separated from the remainder of the clips as the same is driven into the surface.

13. (canceled)

14. The dispenser apparatus according to claim 12 wherein the storage means are range taking in that guide means provided within the same receive, or are adapted to receive cassettes, cartridges or magazines with different sizes of clips within a range of clip sizes.

15. The dispenser apparatus according to claim 1 wherein the clip includes a body provided with a recess to allow the location of a portion of an elongate member therein.

16. The dispenser apparatus according to claim 15 wherein the clip is provided with a larger recess, or plurality of recesses, in order to allow a number of elongate member portions to be located therein side by side.

17. The dispenser apparatus according to claim 1 wherein the clips are joined together in a stepped configuration, with the leading clip being at one end and the last clip at the opposing end.

18. The dispenser apparatus according to claim 17 wherein the securing means in each clip has a longitudinal axis along which the same is driven and the longitudinal axes of said respective clips are substantially parallel when the clips are joined together.

19. (canceled)

20. The dispenser apparatus according to claim 17 wherein the join between adjacent clips is achieved by a web of material which extends between adjacent clips.

21. The dispenser apparatus according to claim 17 wherein a dovetail join is provided between adjacent clips.

22. (canceled)

23. (canceled)

24. A supply of clips, each clip including a body with location means for location of a portion of an elongate member therein and an engagement portion with a channel for the receipt of a securing means in the form of a nail and wherein the clips are arranged with a leading clip joined to the following clip and the successive adjacent clips are joined together to form the clip supply.

25. A supply according to claim 24 wherein the join between successive adjacent clips is achieved by a portion of material which can be broken to release a leading clip from the supply.

26. A supply according to claim 24 wherein the join is created by a joint with one of the clips including a male joining formation and the adjacent clip including a female joining formation such that the relative movement of the leading clip with respect to the adjacent clip while the leading clip is being moved into the engaging position allows the male and female joining formations to slide apart and hence free the leading clip from the clip supply.

27. A supply according to claim 24 wherein the clips are joined together in a stepped configuration with the securing means of the respective clips each having a longitudinal axis and the said axes are substantially parallel.

28. A dispenser apparatus for dispensing a clip for securing an elongate member in position, said apparatus including;
a) a housing having a surface with a base portion including an aperture through which a said clip including a body portion and at least one securing means is dispensed,
b) a driver assembly adapted to be movable to contact the securing means of the clip to drive the said securing means of the clip positioned at the aperture into a surface, and
c) a storage means to receive a plurality of clips and to allow a leading clip of the plurality of clips to be positioned at the said aperture to be dispensed and wherein the said plurality of clips are provided as a magazine, cartridge or cassette of the clips.

29. (canceled)

30. (canceled)

31. (canceled)

32. (canceled)

33. (canceled)

34. Apparatus for the fixing of clips to a surface to retain an elongate member in position with respect to the said surface, each of said clips including a body portion and a nail, said dispensing means has a housing with a dispensing aperture through which a nail of the clip is dispensed and a driver assembly is provided in the housing which is operable to drive the nail into the surface to which the clip and elongate member are to be fixed and thereby fix the clip body portion and elongate member in position, wherein said nails are successively dispensed from a magazine, cassette or cartridge located with the housing and from magazine, cassette or cartridge the leading nail is separated and dispensed by the use of the apparatus and the driver assembly is powered by a power source connected to the apparatus and operates in response to user actuation of actuation means provided on the apparatus to impart a drive force on said nail to drive and dispense the same from the dispensing aperture.
